(19) United States
(12) Patent Application Publication
(10) Pub. No.: US 2008/0252251 A1
(43) Pub. Date: Oct. 16, 2008

(54) SYSTEM FOR RECHARGING BATTERY-OPERATED DEVICES

(76) Inventor: Mickael Collins Joasil, Nepean (CA)

Correspondence Address: MCNEES WALLACE & NURICK LLC, 100 PINE STREET, P.O. BOX 1166, HARRISBURG, PA, 17108-1166, US

(21) Appl. No.: 12/100,030

(22) Filed: Apr. 9, 2008

Related U.S. Application Data
(60) Provisional application No. 60/968,980, filed on Aug. 30, 2007.
(60) Provisional application No. 60/911,158, filed on Apr. 11, 2007.

(51) Int. Cl. H02J 7/32

(52) U.S. Cl. 320/101; 320/113; 320/110

(57) ABSTRACT

A system for charging rechargeable devices is provided. This system includes a base, wherein the base further includes: a plurality of power sources; at least one rechargeable battery in electrical communication with the plurality of power sources; and a plurality of recharging ports in electrical communication with the at least one rechargeable battery. The system also includes at least one rechargeable device, wherein the at least one rechargeable device is adapted to be compatible with at least one of the plurality of recharging ports, and wherein the at least one rechargeable battery in the base provides energy sufficient to charge the at least one rechargeable the device.

### CROSS-REFERENCE TO RELATED APPLICATIONS

This patent application claims the benefit of U.S. Provisional Patent Application Ser. No. 60/911,158 filed on Apr. 11, 2007 and entitled “System for Recharging Battery-Operated Devices”, and U.S. Provisional Patent Application Ser. No. 60/968,980 filed on Aug. 30, 2007 and entitled “System for Recharging Batter-Operated Devices”, the disclosures of which is incorporated by reference as if fully rewritten herein.

### BACKGROUND OF THE INVENTION

The described invention relates in general to a system for recharging battery-operated devices, and more specifically to a system for recharging different types of battery operated device, wherein the system itself includes a rechargeable battery as a power source, and wherein the rechargeable battery may itself be recharged from a plurality of different electrical power sources that are part of the system.

Rechargeable electronic devices are commonplace in modern society. Daily use of wireless devices such as cell phones and wireless e-mail devices typically involves recharging the batteries in such devices on a regular basis using a variety of different chargers. Most chargers used with wireless devices plug into a standard 120 volt AC outlet, which provides the electricity necessary for recharging one or more electronic devices. In the event that electric power is lost or interrupted for a significant length of time, most chargers will become useless and the devices with which they are used will eventually lose their charge and cease to operate. Thus, there is a need for a charger that can draw electric power from a variety of sources, including somewhat atypical sources, and then store that electric power for use when needed to recharge battery-operated devices.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a system for charging rechargeable devices is provided. This system includes a base, wherein the base further includes: a plurality of power sources; at least one rechargeable battery in electrical communication with the plurality of power sources; and a plurality of recharging ports in electrical communication with the at least one rechargeable battery. The system further includes at least one rechargeable device, wherein the at least one rechargeable device is adapted to be compatible with at least one of the plurality of recharging ports, and wherein the at least one rechargeable battery in the base provides energy sufficient to charge the at least one rechargeable the device.

In accordance with another aspect of the present invention, a system for recharging battery-operated devices is provided. This system includes a base, wherein the base further includes: at least one primary source of electric power; at least one secondary source of electric power in electrical communication with the at least one primary source of electric power; and a plurality of recharging ports in electrical communication with the at least one secondary source of electric power, wherein the plurality of recharging ports further includes ports for recharging different types of rechargeable devices. The system further includes at least one rechargeable device in electrical communication at least one of the plurality of recharging ports, wherein the at least one secondary source of electric power provides energy sufficient to charge the at least rechargeable the device; and at least one programmable microprocessor for controlling the system.

In yet another aspect of this invention, a system for charging rechargeable battery-operated devices is provided. This system includes a base, wherein the base further includes: a plurality of power sources, wherein the plurality of power sources further includes an AC/DC power source, at least one photovoltaic cell, and at least one hand-operated dynamo generator; at least one rechargeable battery in electrical communication with the plurality of power sources; and a plurality of recharging ports in electrical communication with the at least one rechargeable battery. This system further includes at least one rechargeable device, wherein the at least one rechargeable device is adapted to be compatible with at least one of the plurality of recharging ports, and wherein the at least one rechargeable battery provides energy sufficient to charge the at least one rechargeable the device; and at least one controller for operating the system.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a cross-sectional side view of an exemplary embodiment of the system of the present invention showing the placement of the various system components within the base;

FIG. 2 is a cross-sectional side view of one of the exemplary rechargeable, battery-operated light bulbs of the present invention showing the placement of the various bulb components within the housing of the light bulb; and

FIG. 3 is a simplified flowchart depicting an exemplary arrangement of the components of the system of FIG. 1.

### DETAILED DESCRIPTION OF THE INVENTION

### Reference Numerals

100 system for recharging battery operated devices
110 base/housing
112 internal rechargeable battery
114 AC power source
115 transformer
116 DC input
118 solar panel/photovoltaic cell
120 dynamo generator
122 crank for dynamo generator
130 recharging port for light bulbs
132 recharging port for rechargeable devices
150 PC board/charging circuits
200 rechargeable light bulb
210 battery case
212 rechargeable battery
214 base
216 positive charging plate
218 negative charging plate
220 on/off switch
230 LED
300 rechargeable device

Exemplary embodiments of the present invention are now described with reference to the Figures. Reference numerals are used throughout the detailed description to refer to the various elements and structures. In other instances, well-known structures and devices are shown in block diagram form for purposes of simplifying the description. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates to a fully-integrated, self-contained recharging station for use with battery-operated electronic devices. As previously indicated, a first general embodiment of this invention provides a system for charging rechargeable devices; a second general embodiment of this invention provides a microprocessor-controlled system for recharging battery-operated devices; and a third general embodiment of this invention provides a system for charging rechargeable battery-operated devices such as rechargeable light bulbs and wireless e-mail devices. With reference now to the Figures, one or more specific embodiments of this invention shall be described in greater detail.

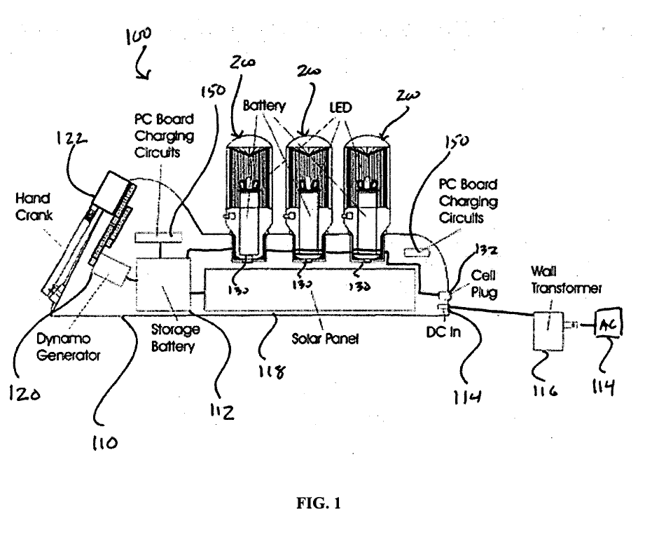

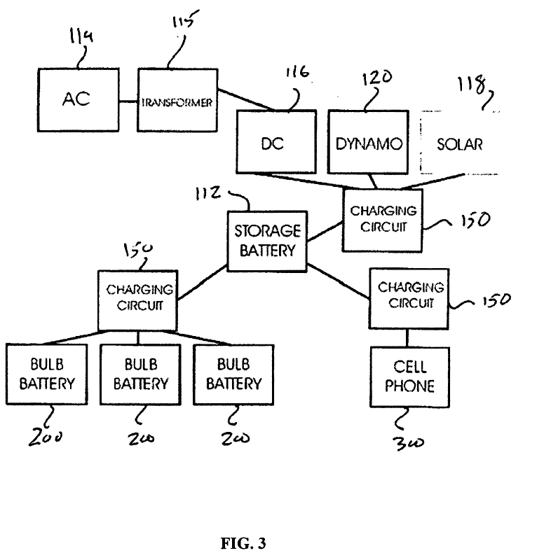

As shown in FIGS. 1 and 3, an exemplary embodiment of recharging system 100 includes base 110, which further includes a plastic or metal housing that is adapted to receive an internal power source, i.e., at least one rechargeable battery 112 and at least one microprocessor-controlled charging circuit 150 in communication with the at least one rechargeable battery 112. As will be appreciated by the skilled artisan, a variety of commercially available programmable and/or non-programmable microprocessors are compatible with this invention. Battery 112 is typically completely enclosed within base 110 and draws and stores electric power from at least one of several different initial or primary energy sources. In the exemplary embodiment shown in the Figures, these primary energy sources include an AC power source 114, which utilizes DC transformer/converter 115 and is connected to DC input 116; at least one solar panel or photovoltaic cell 118; and at least one manually-operated dynamo generator 120 that includes a hand-crank 122 for generating electricity with dynamo 120. All of these primary energy sources may be used to charge internal battery 112 (which is essentially a “secondary” or alternate power source), which may then be used to power and/or charge devices that are attached to the charging station of the present invention at recharging ports 130, which are used for rechargeable light bulbs 200, and recharging ports 132, which are used for other rechargeable devices 300, such as cell phones, digital playback devices, wireless e-mail devices, and the like. Recharging of internal battery 112 may be continuous or intermittent. In some embodiments, the recharging system 100 includes a bypass switch and circuit which allows devices attached to the power station, e.g., light bulbs 200, to be charged or recharged directly by one or more of the initial power sources rather than by internal battery or batteries. Some embodiments of the present invention include various device adapters (not shown in the Figures) that are useful with electronic equipment and make such equipment compatible with system 100.

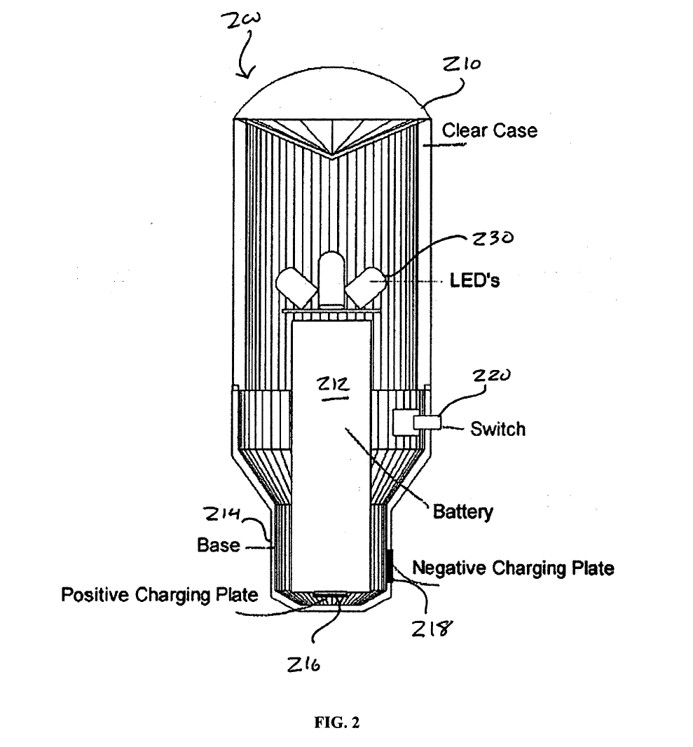

As shown in FIG. 2, base 110 is adapted to receive at least one, and preferably a plurality of battery-operated rechargeable light bulbs 300. These bulbs are connected to the recharging station of the present invention at a series of recharging receptacles or ports 130 located along the top edge thereof. In an exemplary embodiment, each light bulb 200 includes plastic case 210, rechargeable 3.7V lithium battery 212 (AA size; although any suitable rechargeable battery may be incorporated into the bulbs), base 214, positive charging plate 216, negative charging plate 218, and on/off switch 220. As shown in FIG. 2, the exemplary bulbs also include 4 light-emitting diodes (LEDs) 230, three of which are substantially oval and one of which is substantially straight. Other LED configurations are possible. The base of each bulb is typically threaded to fit standard light fixtures and sockets. In some embodiments of this invention, the rechargeable light bulbs may draw charging energy from the light fixtures in which they are mounted, in addition to drawing energy from recharging system 100 when mounted in base 110.

As previously indicated, in addition to the plurality of light bulb recharging ports 130, charging/recharging system 100 includes a variety of other ports 132 for connecting and recharging other devices 300. More specifically, exemplary embodiments includes peripheral recharging receptacles or ports 132 for cell phones, computers, digital playback devices, wireless e-mail devices, personal digital assistants, and/or other electronic and digital devices. These ports 132 may include USB-type connectors or any other suitable connectors and/or adapters known to those of ordinary skill in the art. Devices attached to the recharging station of the present invention at the peripheral ports may be charged either by drawing on energy stored in internal battery 112 or by drawing on energy provided directly by the other power sources. Bypass circuitry may be included within base 110 for allowing the user of system 100 to choose a desired power source for charging the rechargeable devices. The microprocessor included with this invention may provide the user of system 100 with the option of selecting one or more primary sources preferentially when charging internal battery 112 or any of the external rechargeable devices attached thereto.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A system for charging rechargeable devices, comprising:
(a) a base, wherein the base further includes:
(i) a plurality of power sources;
(ii) at least one rechargeable battery in electrical communication with the plurality of power sources; and
(iii) a plurality of recharging ports in electrical communication with the at least one rechargeable battery; and
(b) at least one rechargeable device, wherein the at least one rechargeable device is adapted to be compatible with at least one of the plurality of recharging ports, and wherein the at least one rechargeable battery in the base provides energy sufficient to charge the at least one rechargeable the device.

2. The system of claim 1, further comprising at least one microprocessor for controlling the operation of the system.

3. The system of claim 1, wherein the power sources further include AC/DC power, photovoltaic cells, hand-operated dynamo generators, and combinations thereof.

4. The system of claim 1, wherein the at least one rechargeable device is a rechargeable light bulb.

5. The system of claim 4, wherein the at least one rechargeable light bulb further includes at least one light-emitting diode.

6. The system of claim 1, wherein the at least one rechargeable device is a mobile phone, a digital playback device, a wireless e-mail device, a personal digital assistant, or a computer.

7. A system for recharging battery-operated devices, comprising:
(a) a base, wherein the base further includes:
(i) at least one primary source of electric power;
(ii) at least one secondary source of electric power in electrical communication with the at least one primary source of electric power; and
(iii) a plurality of recharging ports in electrical communication with the at least one secondary source of electric power, wherein the plurality of recharging ports further includes ports for recharging different types of rechargeable devices; and
(b) at least one rechargeable device in electrical communication at least one of the plurality of recharging ports, wherein the at least one secondary source of electric power provides energy sufficient to charge the at least rechargeable the device; and
(c) at least one microprocessor for controlling the system.

8. The system of claim 7, wherein the at least one primary source of electric power further includes AC/DC power, at least one photovoltaic cell, and at least one hand-operated dynamo generator.

9. The system of claim 7, wherein the at least one secondary source of electric power further includes a rechargeable battery.

10. The system of claim 7, wherein the at least one rechargeable device is a rechargeable light bulb.

11. The system of claim 10, wherein the rechargeable light bulb further includes at least one light-emitting diode.

12. The system of claim 7, wherein the at least one rechargeable device is a mobile phone, a digital playback device, a wireless e-mail device, a personal digital assistant or a computer.

13. The system of claim 7, wherein the plurality of recharging ports further includes a plurality of adapters for accommodating different rechargeable devices.

14. A system for charging rechargeable battery-operated devices, comprising:
(a) a base, wherein the base further includes:
(i) a plurality of power sources, wherein the plurality of power sources further includes an AC/DC power source, at least one photovoltaic cell, and at least one hand-operated dynamo generator;
(ii) at least one rechargeable battery in electrical communication with the plurality of power sources; and
(iii) a plurality of recharging ports in electrical communication with the at least one rechargeable battery; and
(b) at least one rechargeable device, wherein the at least one rechargeable device is adapted to be compatible with at least one of the plurality of recharging ports, and wherein the at least one rechargeable battery provides energy sufficient to charge the at least one rechargeable the device; and
(c) at least one controller for operating the system.

15. The system of claim 14, wherein the at least one rechargeable device is a rechargeable light bulb.

16. The system of claim 15, wherein the rechargeable light bulb further includes at least one light-emitting diode.

17. The system of claim 14, wherein the at least one rechargeable device is a mobile phone, a digital playback device, a wireless e-mail device, a personal digital assistant or a computer.

18. The system of claim 14, wherein the plurality of recharging ports further includes a plurality of adapters for accommodating different rechargeable devices.

19. The system of claim 14, wherein the at least one controller further comprises a microprocessor.

20. The system of claim 19, wherein the microprocessor is programmable.
